(19) United States
(12) Patent Application Publication
(10) Pub. No.: US 2021/0033831 A1
(43) Pub. Date: Feb. 4, 2021

(54) ZOOM LENS, IMAGE PROJECTION APPARATUS, AND IMAGE PICKUP APPARATUS

(71) Applicant: CANON KABUSHIKI KAISHA, Tokyo (JP)

(72) Inventor: Shuichi Kurokawa, Saitama-shi (JP)

(21) Appl. No.: 16/938,636

(22) Filed: Jul. 24, 2020

(30) Foreign Application Priority Data
Aug. 2, 2019 (JP) 2019-142672

(51) Int. Cl. G02B 15/14; G02B 13/18

(52) U.S. Cl. CPC G02B 15/1421; G02B 13/18

(57) ABSTRACT

A zoom lens includes, in order from a reduction conjugate side to an enlargement conjugate side, a first optical system having a positive refractive power, and a second optical system having positive refractive power. The second optical system reimages an intermediate image formed by the first optical system. The second optical system does not move during zooming. The first optical system includes a first lens unit that moves during zooming and has a positive refractive power, a second lens unit that moves during zooming and has a negative refractive power, and a third lens unit that moves during zooming and has a positive refractive power. A distance between adjacent lens units in the first optical system changes during zooming.

### BACKGROUND OF THE INVENTION

### Field of the Invention

The present invention relates to a zoom lens that uses for an image projection apparatus and an image pickup apparatus.

### Description of the Related Art

As a projection optical system of an image projection apparatus, a zoom lens having a zooming function for varying a size of a projection image has been widely used. Such a projection optical system is required to secure a back focus and have excellent telecentricity. To meet these requirements, a retrofocus type projection optical system is usually used. Further, to make it possible to project a large image at a short distance, it is desired to widen an angle of the projection optical system. However, widening the angle of the retrofocus type projection optical system makes a diameter of a lens closest to the projection surface larger.

Japanese Patent Laid-Open No. (“JP”) 2018-36389 discloses a zoom lens to enlarge and project an image formed by imaging a display image of an image display element using a refractive optical system onto a projection surface using another refractive optical system to suppress enlargement of a lens closest to a projection surface.

However, the zoom lens disclosed in JP 2018-36389 cannot sufficiently correct distortion and does not satisfy desired optical characteristics.

### SUMMARY OF THE INVENTION

The present invention provides a wide angle and compact zoom lens having excellent optical characteristics, an image projection apparatus, and an image pickup apparatus.

A zoom lens according to one aspect of the present invention includes, in order from a reduction conjugate side to an enlargement conjugate side, a first optical system having a positive refractive power, and a second optical system having positive refractive power. The second optical system reimages an intermediate image formed by the first optical system. The second optical system does not move during zooming. The first optical system includes a first lens unit that moves during zooming and has a positive refractive power, a second lens unit that moves during zooming and has a negative refractive power, and a third lens unit that moves during zooming and has a positive refractive power. A distance between adjacent lens units in the first optical system changes during zooming.

Further features of the present invention will become apparent from the following description of exemplary embodiments with reference to the attached drawings.

### BRIEF DESCRIPTION OF THE DRAWINGS

FIG. 1 is an optical path diagram of a projection optical system according to a first embodiment at a wide angle end.

FIG. 2 is an aberration diagram of the projection optical system according to the first embodiment.

FIG. 3 is an optical path diagram of a projection optical system according to a second embodiment at a wide angle end.

FIG. 4 is an aberration diagram of the projection optical system according to the second embodiment.

FIG. 5 is an optical path diagram of a projection optical system according to a third embodiment at a wide angle end.

FIG. 6 is an aberration diagram of the projection optical system according to the third embodiment.

FIG. 7 is an optical path diagram of a projection optical system according to a fourth embodiment at a wide angle end.

FIG. 8 is an aberration diagram of the projection optical system according to the fourth embodiment.

FIG. 9 is an optical path diagram of a projection optical system according to a fifth embodiment at a wide angle end.

FIG. 10 is an aberration diagram of the projection optical system according to the fifth embodiment.

FIG. 11 is an optical path diagram of a projection optical system according to a sixth embodiment at a wide angle end.

FIG. 12 is an aberration diagram of the projection optical system according to the sixth embodiment.

FIG. 13 is an optical path diagram of a projection optical system according to a seventh embodiment at a wide angle end.

FIG. 14 is an aberration diagram of the projection optical system according to the seventh embodiment.

FIG. 15 is a schematic diagram of an image projection apparatus including a zoom lens according to each embodiment.

FIG. 16 is a schematic diagram of an image pickup apparatus including the zoom lens according to each embodiment.

### DESCRIPTION OF THE EMBODIMENTS

Referring now to the accompanying drawings, a detailed description will be given of embodiments according to the present invention. It should be noted that drawings may be drawn at a scale different from an actual scale in order to facilitate understanding of the present invention.

### First Embodiment

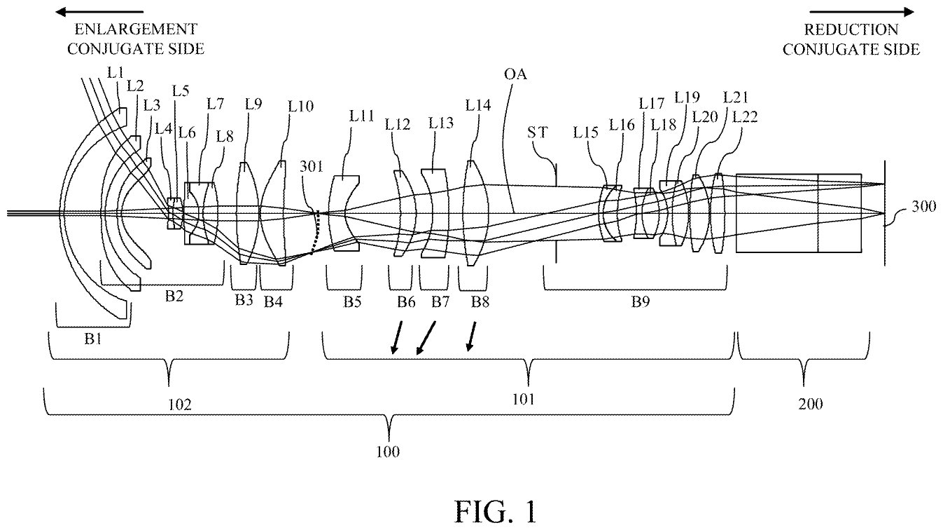

Referring now to FIG. 1, a description will be given of a projection optical system 100 according to a first embodiment. FIG. 1 is an optical path diagram of the projection optical system 100 according to this embodiment. Since the projection optical system 100 is a zoom lens (zooming optical system) having the zooming function, FIG. 1 illustrates the optical path diagram at a wide angle end when a projection distance is 655 mm.

The projection optical system 100 includes, in order from the enlargement conjugate side to the reduction conjugate side, lens units B1, B2, B3, B4, B5, B6, B7, B8, and B9 respectively having negative, negative, positive, positive, negative, positive, negative, positive, and positive power (refractive power). ST denotes an aperture stop. The lens unit B1 includes a lens L1. The lens unit B2 includes lenses L2 to L8. The lens unit B3 includes a lens L9. The lens unit B4 includes a lens L10. The lens unit B5 includes a lens L11. The lens unit B6 includes a lens L12. The lens unit B7 includes a lens L13. The lens unit B8 includes a lens L14. The lens unit B9 includes the aperture stop ST and lenses L15 to L22. Of these lens units, five lens units B5 to B9 form a first optical system 101, and four lens units B1 to B4 form a second optical system 102.

A color separation/combination optical system 200 having a prism is inserted between the first optical system 101 and a light modulation element 300 that is a reduction side conjugate plane. The color separation/combination optical system 200 guides light modulated by the light modulation element 300 to the projection optical system 100. A liquid crystal panel or a micromirror device is used as the light modulation element 300.

The first optical system 101 forms an intermediate image 301 which is a conjugate image of the light modulation element 300, and the second optical system 102 reimages the intermediate image 301 onto an enlargement side conjugate plane (not illustrated). In the projection optical system 100 according to this embodiment, the second optical system 102 mainly widens the angle, and the first optical system 101 secures a back focus and excellent telecentricity. The second optical system 102 corrects a residual aberration of the first optical system 101.

Further, correcting the distortion using the second optical system 102, which is a retrofocus type optical system, is difficult, but arranging the lens unit B5 (fixed lens) having negative power on the most enlargement conjugate side of the first optical system 101 can correct the distortion remaining in the second optical system 102. With such a configuration, it is possible to realize excellent optical performance (optical characteristics) despite the wide angle. Thus, the back focus of the second optical system 102, which widens the angle, can be shortened as compared with a normal zoom lens that does not have an intermediate image, so that the diameter of the lens closest to the enlargement conjugate side can be reduced.

In this embodiment, zooming (magnification) is performed by changing a distance between the lens units included in the first optical system 101. Specifically, zooming is performed by moving three lens units (a plurality of lens units) B6, B7, and B8 in a direction (optical axis direction) along an optical axis OA of the first optical system 101 on different loci. That is, during zooming, the distance between adjacent lens units in the first optical system 101 changes.

The aperture stop ST is a part of the lens unit B9 and does not move (fixed) during zooming. As a result, a zoom lens that does not cause a change in F-number due to zooming can be obtained. Further, fixing the second optical system 102 during zooming performs zooming of the intermediate image as the optical effect, and enables the configuration of the second optical system 102 to be simplified.

Thus, the back focus of the second optical system 102 can be shortened, and the projection optical system 100 can be downsized. In addition, the lens units B6, B7, and B8 that move during zooming are integrated in the first optical system 101, and thus a zoom cam configuration can be simplified.

Tables 1(A) to 1(C) show various values of the projection optical system 100 according to this embodiment. Table 1(A) shows a lens configuration, f is a focal length, Fno is a F-number, and co is a half angle of view (degree). The sign of the focal length is negative, but because an intermediate image is formed, erect images are imaged on the enlargement side conjugate plane and the reduction side conjugate plane, and the projection optical system 100 has a positive power. In addition, r (mm) is a paraxial curvature radius of each surface from the enlargement conjugate side, d (mm) is a distance between each surface and next surface, n is a refractive index of each optical member for the d-line, and v is an Abbe number. ST denotes the aperture stop. The surface marked with “*” on the left side has an aspherical shape expressed by the following expression (1). y is a radial distance from the optical axis, z is a sag amount of the surface in the optical axis direction, r is the paraxial curvature radius, and k is a conic coefficient. The sign of z in the direction from the enlargement conjugate side to the reduction conjugate side is positive.

$$z = \frac{\frac{{y}^{2}}{r}}{1 + \sqrt{1 - ( 1 + k ) {( \frac{y}{r} )}^{2}}} + {\sum }_{j = 1}^{16} {B}_{j} {y}^{j} \qquad ( 1 )$$

Table 1(B) shows the coefficient of each surface having the aspherical shape. In Table 1(B), “E±x” means “10^{±x}”. In addition, all coefficients not specifically described are 0. Table 1(C) shows the values at the wide angle end and the telephoto end for each surface interval (unit interval) that changes during zooming.

In this embodiment, the lens units B6, B7, and B8 move to the enlargement conjugate side during zooming from the wide angle end to the telephoto end. In the wide angle projection optical system 100 as in this embodiment, to achieve excellent optical performance in the entire zoom range, it is necessary to satisfactorily correct the astigmatism fluctuations and the distortion fluctuations during zooming. Thus, in this embodiment, the lens unit B6 having the positive power and the lens unit B7 having the negative power correct the astigmatism fluctuations and the distortion fluctuations during zooming. However, since the lens units B6 and B7 cannot correct the distortion fluctuations sufficiently, the lens unit B8 having the positive power corrects the distortion fluctuations that cannot be completely corrected by the lens units B6 and B7.

In this embodiment, the lens unit (first lens unit) B6 having the positive refractive power, the lens unit (second lens unit) B7 having the negative refractive power, and the lens unit (third lens unit) B8 having the positive refractive power are arranged as a plurality of lens units that move during zooming. Thereby, excellent optical performance can be achieved in the entire zoom range.

When fm is a focal length of the lens unit B7 having the negative refractive power, fp1 is a focal length of the lens unit B6 having the positive refractive power, and fp2 is a focal length of the lens unit B8 having the positive refractive power, the projection optical system 100 may satisfy the following conditional expressions (2) and (3).

$$\begin{matrix}- 1.5 < \frac{fp 1}{fm} < 0 & ( 2 ) \\ - 1.5 < \frac{fp 2}{fm} < 0 & ( 3 )\end{matrix}$$

The conditional expressions (2) and (3) respectively define the ratio of the focal length fp1 and the focal length fm, and the ratio of the focal length fp2 and the focal length fm. If the upper limit or the lower limit of each of conditional expressions (2) and (3) is exceeded, it becomes difficult to compatibly correct the astigmatism fluctuations and the distortion fluctuations.

The projection optical system 100 may satisfy the following conditional expressions (2a) and (3a).

$$\begin{matrix}- 1 < \frac{fp 1}{fm} < - 0 .003 & ( 2 a ) \\ - 1 < \frac{fp 2}{fm} < - 0.0 \; 03 & ( 3 a )\end{matrix}$$

The focal lengths fp1 and fp2 may satisfy the following conditional expression (4).

$$0.3 < \frac{fp 1}{fp 2} < 3.3 \qquad ( 4 )$$

The conditional expression (4) defines the ratio of the focal length fp1 and the focal length fp2. If the upper limit or the lower limit of the conditional expression (4) is exceeded, the astigmatism fluctuations or the distortion fluctuations become overcorrected, and it becomes difficult to achieve excellent optical performance.

The projection optical system 100 may satisfy the following conditional expression (4a).

$$0.4 < \frac{fp 1}{fp 2} < 2.5 \qquad ( 4 a )$$

In the projection optical system 100 according to this embodiment, the focal length of the lens unit B6 is 65.67 mm, the focal length of the lens unit B7 is −69.22 mm, and the focal length of the lens unit B8 is 52.13 mm. Thus, the projection optical system 100 satisfies the conditional expressions (2a), (3a), and (4a).

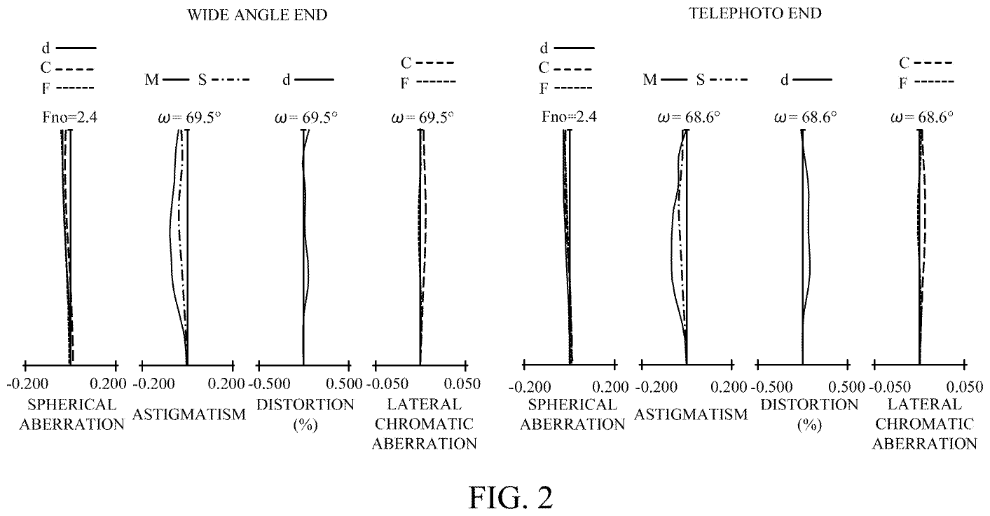

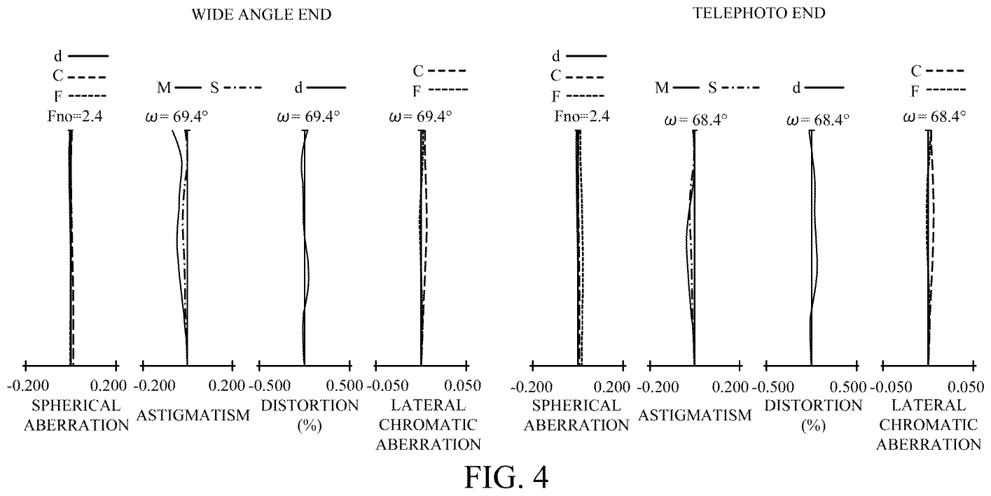

Referring now to FIG. 2, a description will be given of the optical performance of the projection optical system 100. FIG. 2 is an aberration diagram of the projection optical system 100 at the wide angle end and the telephoto end when the projection distance is 655 mm. FIG. 2 illustrates the spherical aberration for the d-line, the C-line, and the F-line, the field curvature and the astigmatism for the d-line, the distortion for the d-line, and the lateral chromatic aberration for the C-line and the F-line. The range of the abscissa axis in FIG. 2 is ±0.2 mm for the spherical aberration, and the field curvature/the astigmatism, ±0.5% for the distortion, and ±0.05 mm for the lateral chromatic aberration. These points are the same in FIGS. 4, 6, 8, 10, 12, and 14 relating to each embodiment described later. The aberration diagram of FIG. 2 is an aberration diagram when the enlargement conjugate side is the object side and the reduction conjugate side is the image side. All aberrations are well corrected at the wide angle end and the telephoto end, and the aberration fluctuations due to zooming are suppressed.

The projection optical system 100 is the zoom lens that includes, in order from the reduction conjugate side to the enlargement conjugate side, the first optical system 101 having the positive refractive power and the second optical system 102, and reimages the intermediate image 301 formed by the first optical system 101 using the second optical system 102. That is, the projection optical system 100 includes the first optical system 101 arranged on the reduction conjugate side and the second optical system 102 arranged in the enlarged conjugate side to sandwich the intermediate image 301, and has the zooming function (magnification function). Zooming is performed by moving the three lens units B6, B7, and B8 among the plurality of lens units forming the first optical system 101 along the optical axis OA. The three lens units B6, B7, and B8 respectively have positive, negative, and positive power, the lens units B6 and B7 mainly correct the astigmatism fluctuations during zooming, and the lens unit B8 corrects the remaining distortion fluctuations. With such a configuration, it is possible to realize the zoom lens having the zooming function that suppresses the aberration fluctuations during zooming and achieves a small lens diameter and excellent optical performance while having a wide angle.

In this embodiment, the first optical system 101 includes five lens units B5 to B9, but the number of lens units is not limited to this, and the number of lens units can be changed as described later in other embodiments. However, since the lens unit (moving lens unit) needs to include three lens units having positive, negative, and positive power, the first optical system 101 has at least three lens units. Similarly, regarding the second optical system 102, the number of lens units and the configuration of each lens units are not limited and can be changed as appropriate. Further, although the zoom lens as the projection optical system 100 has been described in this embodiment, but the present invention is not limited to this. The zoom lens according to this embodiment can be also used as an imaging optical system to form an image on an image pickup element. It is also possible to change the back focus according to the intended use.

In this embodiment, the first lens unit, the second lens unit, and the third lens unit are arranged in order from the enlargement conjugate side to the reduction conjugate side, but the present invention is not limited to this. For example, the second lens unit, the first lens unit, and the third lens unit may be arranged in order from the enlargement conjugate side to the reduction conjugate side. Alternatively, the first lens unit, the third lens unit, and the second lens unit may be arranged in order from the enlargement conjugate side to the reduction conjugate side. Further, in this embodiment, the first lens unit, the second lens unit, and the third moving lens are successively arranged, but the present invention is not limited to this.

### Second Embodiment

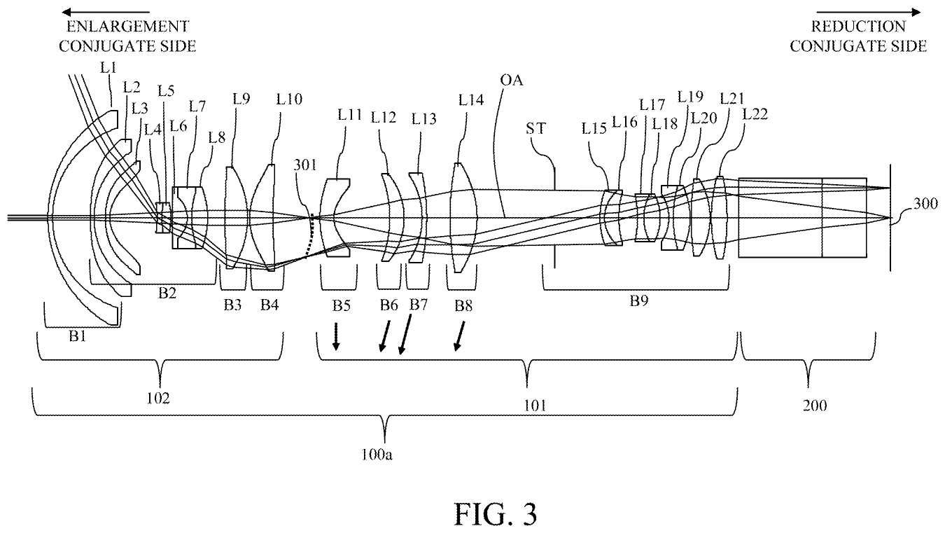

Referring now to FIG. 3, a description will be given of a projection optical system 100a according to a second embodiment. FIG. 3 is an optical path diagram of the projection optical system 100a according to this embodiment. Since the projection optical system 100a is a zoom lens (zooming optical system) having the zooming function, FIG. 3 illustrates the optical path diagram at a wide angle end when a projection distance is 655 mm. In the projection optical system 100a according to this embodiment, the positive and negative power arrangements of each lens unit, the number of lens units forming the first optical system 101, and the number of lens units forming the second optical system 102 are the same as in the first embodiment.

The projection optical system 100a according to this embodiment can further improve astigmatism as compared with the projection optical system 100 according to the first embodiment. This embodiment differs from the first embodiment in that the four lens units B5, B6, B7, and B8 move in the optical axis direction of the first optical system 101 on different loci during zooming. The aperture stop ST is a part of the lens unit B9, and thus the zoom lens does not cause a change in F-number due to zooming.

Tables 2(A) to 2(C) show various values of the projection optical system 100a according to this embodiment. In the projection optical system 100a according to this embodiment, the focal length of the lens unit B6 is 74.56 mm, the focal length of the lens unit B7 is −79.49 mm, and the focal length of the lens unit B8 is 53.97 mm. Thus, the projection optical system 100a satisfies the conditional expressions (2a), (3a), and (4a).

Referring now to FIG. 4, a description will be given of the optical performance of the projection optical system 100a. FIG. 4 is an aberration diagram of the projection optical system 100a at the wide angle end and the telephoto end when the projection distance is 655 mm. All aberrations are well corrected at the wide angle end and the telephoto end, and the aberration fluctuations due to zooming are suppressed. Moreover, astigmatism is improved as compared with the first embodiment.

As described above, in the projection optical system 100a according to this embodiment, zooming is performed by moving the four lens units B5, B6, B7, and B8 among the plurality of lens units forming the first optical system 101 along the optical axis OA. The four lens units B5, B6, B7, and B8 include the three lens units (first to third lens units) having positive, negative, and positive power, further includes the fourth lens unit, and can correct the astigmatism fluctuations and the distortion fluctuations during zooming. With such a configuration, it is possible to realize the zoom lens having the zooming function that suppresses the aberration fluctuations during zooming and achieves a small lens diameter and excellent optical performance while having a wide angle.

### Third Embodiment

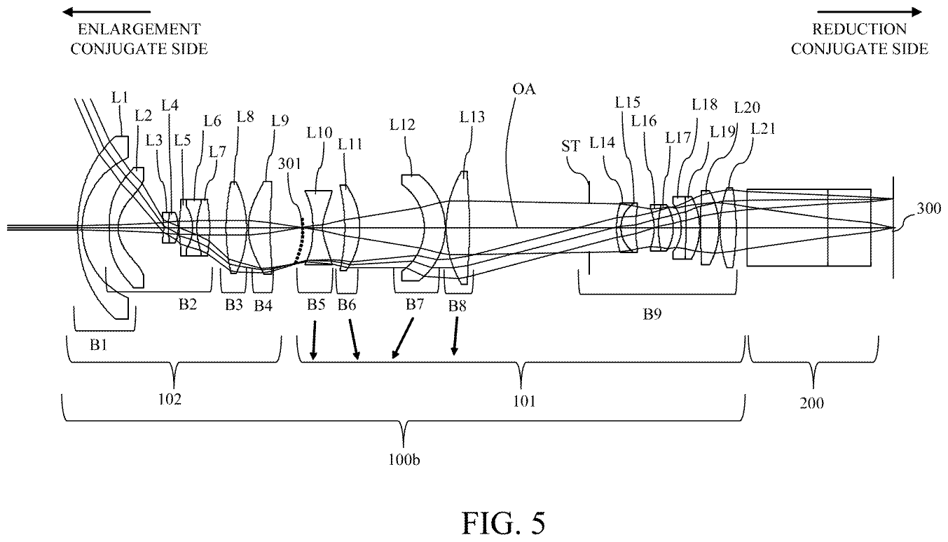

Referring now to FIG. 5, a description will be given of a projection optical system 100b according to a third embodiment. FIG. 5 is an optical path diagram of the projection optical system 100b according to this embodiment. Since the projection optical system 100b is a zoom lens (zooming optical system) having the zooming function, FIG. 5 illustrates the optical path diagram at a wide angle end when a projection distance is 775 mm. In the projection optical system 100b according to this embodiment, the positive and negative power arrangements of each lens unit, the number of lens units forming the first optical system 101, and the number of lens units forming the second optical system 102 are the same as in the first embodiment. However, in the projection optical system 100b according to this embodiment, the number of lenses forming each lens unit is partially different. That is, the lens unit B1 includes the lens L1. The lens unit B2 includes the lenses L2 to L7. The lens unit B3 includes the lens L8. The lens unit B4 includes the lens L9. The lens unit B5 includes the lens L10. The lens unit B6 includes the lens L11. The lens unit B7 includes the lens L12. The lens unit B8 includes the lens L13. The lens unit B9 includes an aperture stop ST and lenses the L14 to L21.

Zooming in this embodiment, as the second embodiment, is performed by moving the four lens units B5, B6, B7, and B8 forming the first optical system 101 in the optical axis direction of the first optical system 101 on different loci. The aperture stop ST is a part of the lens unit B9, and thus the zoom lens does not cause a change in F-number due to zooming.

Tables 3(A) to 3(C) show various values of the projection optical system 100b according to this embodiment. In this embodiment, the focal length of the lens unit B6 is 78.68 mm, the focal length of the lens unit B7 is −514.34 mm, and the focal length of the lens unit B8 is 70.88 mm. Thus, the projection optical system 100b satisfies the conditional expressions (2a), (3a), and (4a).

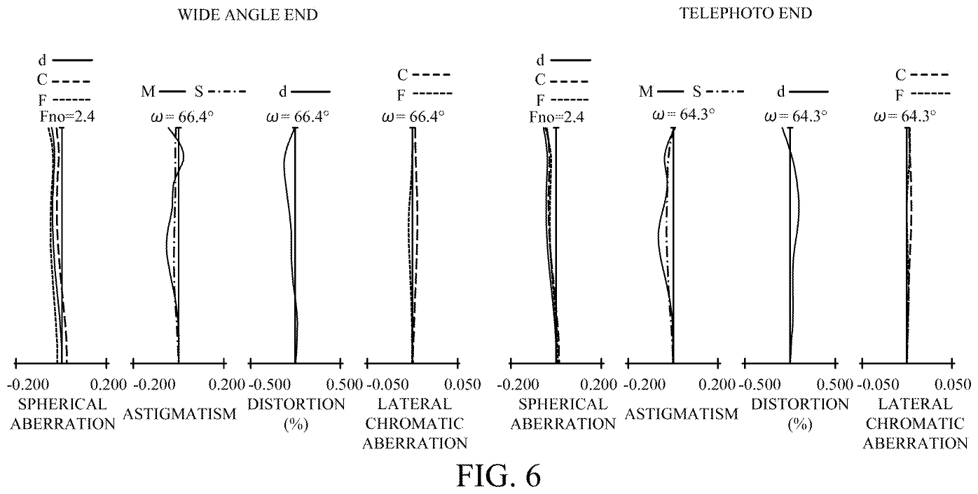

Referring now to FIG. 6, a description will be given of the optical performance of the projection optical system 100b. FIG. 6 is an aberration diagram of the projection optical system 100b at the wide angle end and the telephoto end when the projection distance is 775 mm. All aberrations are well corrected at the wide angle end and the telephoto end, and the aberration fluctuations due to zooming are suppressed.

As described above, in the projection optical system 100b according to this embodiment, zooming is performed by moving the four lens units B5, B6, B7, and B8 among the plurality of lens units forming the first optical system 101 along the optical axis OA. The four lens units B5, B6, B7, and B8 include the three lens units (first to third lens units) having positive, negative, and positive power, further includes the fourth lens unit, and can correct the astigmatism fluctuations and the distortion fluctuations during zooming. With such a configuration, it is possible to realize the zoom lens having the zooming function that suppresses the aberration fluctuations during zooming and achieves a small lens diameter and excellent optical performance while having a wide angle.

### Fourth Embodiment

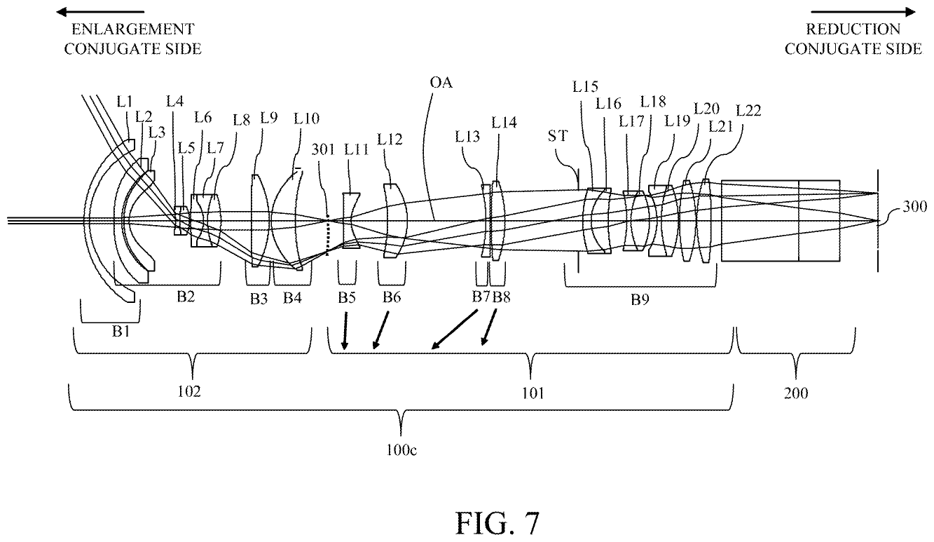

Referring now to FIG. 7, a description will be given of a projection optical system 100c according to a fourth embodiment. FIG. 7 is an optical path diagram of the projection optical system 100c according to this embodiment. Since the projection optical system 100b is a zoom lens (zooming optical system) having the zooming function, FIG. 7 illustrates the optical path diagram at a wide angle end when a projection distance is 968 mm.

The projection optical system 100c includes, in order from the enlargement conjugate side to the reduction conjugate side, lens units B1, B2, B3, B4, B5, B6, B7, B8, and B9 respectively having negative, positive, positive, positive, negative, positive, negative, positive, and positive power. ST denotes an aperture stop. Of the lens units B1 to B9, five lens units B5 to B9 form the first optical system 101, and four lens units B1 to B4 form the second optical system 102. The lens unit B1 includes the lens L1. The lens unit B2 includes the lenses L2 to L8. The lens unit B3 includes the lens L9. The lens unit B4 includes the lens L10. The lens unit B5 includes the lens L11. The lens unit B6 includes the lens L12. The lens unit B7 includes the lens L13. The lens unit B8 includes the lens L14. The lens unit B9 includes the aperture stop ST and the lenses L15 to L22.

Zooming in this embodiment, as the second and third embodiments, is performed by moving the four lens units B5, B6, B7, and B8 forming the first optical system 101 in the optical axis direction of the first optical system 101 on different loci. The aperture stop ST is a part of the lens unit B9, and thus the zoom lens does not cause a change in F-number due to zooming.

Tables 4(A) to 4(C) show various values of the projection optical system 100c according to this embodiment. In this embodiment, the focal length of the lens unit B6 is 53.34 mm, the focal length of the lens unit B7 is −118.85 mm, and the focal length of the lens unit B8 is 69.13 mm. Thus, the projection optical system 100c satisfies the conditional expressions (2a), (3a), and (4a).

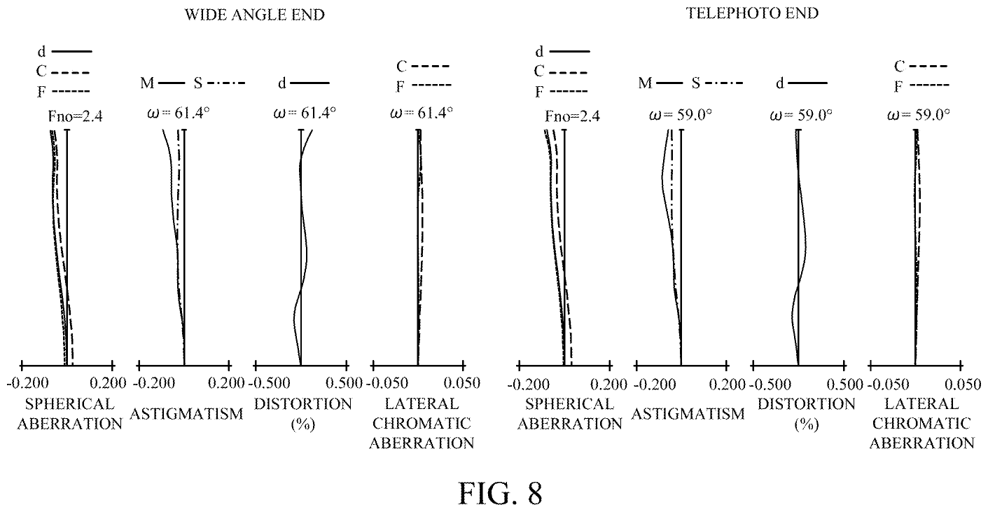

Referring now to FIG. 8, a description will be given of the optical performance of the projection optical system 100c. FIG. 8 is an aberration diagram of the projection optical system 100c at the wide angle end and the telephoto end when the projection distance is 968 mm. All aberrations are well corrected at the wide angle end and the telephoto end, and the aberration fluctuations due to zooming are suppressed.

As described above, in the projection optical system 100c according to this embodiment, zooming is performed by moving the four lens units B5, B6, B7, and B8 among the plurality of lens units forming the first optical system 101 along the optical axis OA. The four lens units B5, B6, B7, and B8 include the three lens units (first to third lens units) having positive, negative, and positive power, further includes the fourth lens unit, and can correct the astigmatism fluctuations and the distortion fluctuations during zooming. With such a configuration, it is possible to realize the zoom lens having the zooming function that suppresses the aberration fluctuations during zooming and achieves a small lens diameter and excellent optical performance while having a wide angle.

### Fifth Embodiment

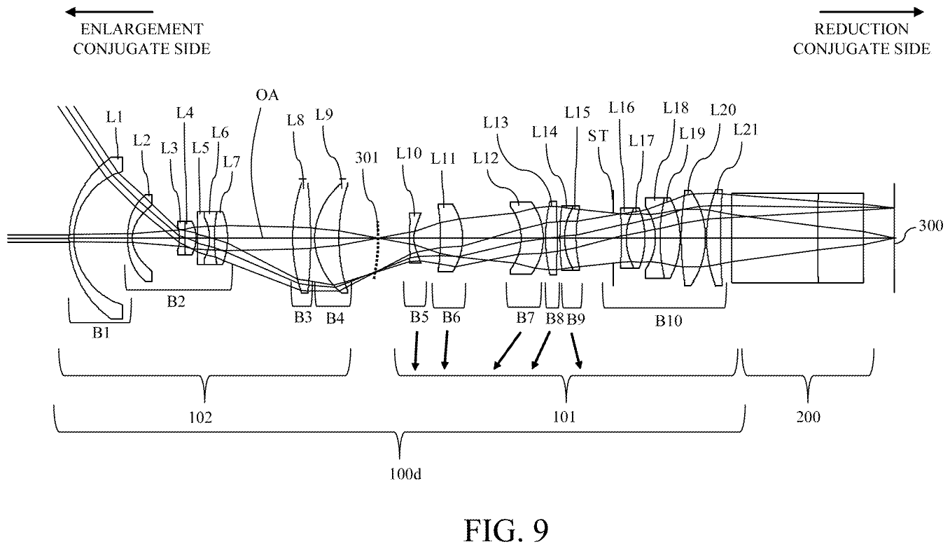

Referring now to FIG. 9, a description will be given of a projection optical system 100d according to a fourth embodiment. FIG. 9 is an optical path diagram of the projection optical system 100d according to this embodiment. Since the projection optical system 100d is a zoom lens (zooming optical system) having the zooming function, FIG. 9 illustrates the optical path diagram at a wide angle end when a projection distance is 1163 mm.

The projection optical system 100d includes, in order from the enlargement conjugate side to the reduction conjugate side, lens units B1, B2, B3, B4, B5, B6, B7, B8, B9, and B10 respectively having negative, positive, positive, positive, negative, positive, negative, positive, negative, and positive power. ST denotes an aperture stop. Of the lens units B1 to B10, six lens units B5 to B10 form the first optical system 101, and four lens units B1 to B4 form the second optical system 102. The lens unit B1 includes the lens L1. The lens unit B2 includes the lenses L2 to L7. The lens unit B3 includes the lens L8. The lens unit B4 includes the lens L9. The lens unit B5 includes the lens L10. The lens unit B6 includes the lens L11. The lens unit B7 includes the lens L12. The lens unit B8 includes the lens L13. The lens unit B9 includes the lenses L14 and L15. The lens unit B10 includes the aperture stop ST and the lenses L16 to L21.

Zooming in this embodiment is performed by moving the five lens units B5, B6, B7, B8, and B9 forming the first optical system 101 in the optical axis direction of the first optical system 101 on different loci. The aperture stop ST is a part of the lens unit B10, and thus the zoom lens does not cause a change in F-number due to zooming.

In this embodiment, the zoom ratio is increased by making the number of lens units (lens units B5 to B9) moving during zooming larger than that in the first to fourth embodiments. However, five lens units B5, B6, B7, B8, and B9, which move during zooming, respectively have negative, positive, negative, positive, and negative power, and includes at least three lens units (moving lens units) having positive, negative and positive power as the first to fourth embodiments

Tables 5(A) to 5(C) show various values of the projection optical system 100d according to this embodiment. In this embodiment, the focal length of the lens unit B6 is 38.72 mm, the focal length of the lens unit B7 is −1026.45 mm, and the focal length of the lens unit B8 is 68.34 mm. Thus, the projection optical system 100d satisfies the conditional expressions (2a), (3a), and (4a). Further, the focal length of the lens unit B9 is 1593.65 mm, and even when the lens unit B9 is used as a lens unit having negative power instead of the lens unit B7, the conditional expressions (2a), (3a), and (4a) are satisfied. That is, the three lens units having positive, negative, and positive power need not be successive lens units in this order.

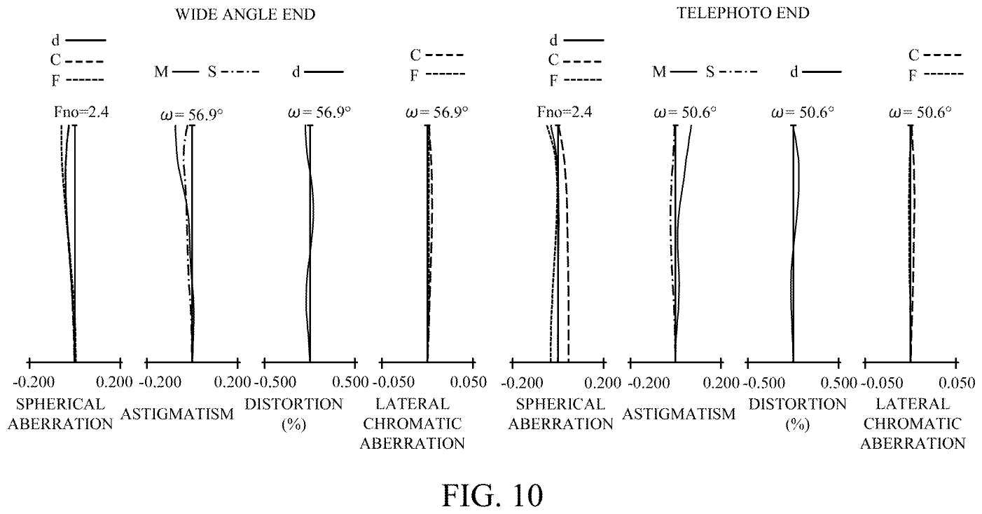

Referring now to FIG. 10, a description will be given of the optical performance of the projection optical system 100d. FIG. 10 is an aberration diagram of the projection optical system 100d at the wide angle end and the telephoto end when the projection distance is 1163 mm. All aberrations are well corrected at the wide angle end and the telephoto end, and the aberration fluctuations due to zooming are suppressed.

As described above, in the projection optical system 100d according to this embodiment, zooming is performed by moving the five lens units B5, B6, B7, B8, and B9 among the plurality of lens units forming the first optical system 101 along the optical axis OA. The five lens units B5, B6, B7, B8, and B9 include the three lens units (first to third lens units) having positive, negative, and positive power, further includes the fourth and fifth lens units, and can correct the astigmatism fluctuations and the distortion fluctuations during zooming. With such a configuration, it is possible to realize the zoom lens having the zooming function that suppresses the aberration fluctuations during zooming and achieves a small lens diameter and excellent optical performance while having a wide angle. In this embodiment, for the sake of simplifying the configuration, for example, a moving lens unit (a part of a plurality of lens units) having a small moving amount may be used as the fixed lens unit under the condition that the optical performance standard is satisfied.

### Sixth Embodiment

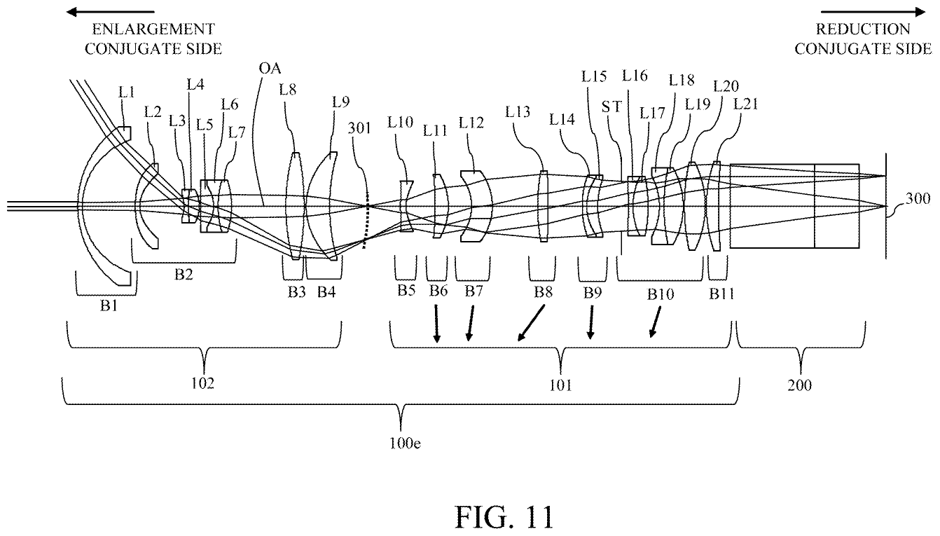

Referring now to FIG. 11, a description will be given of a projection optical system 100e according to a sixth embodiment. FIG. 11 is an optical path diagram of the projection optical system 100e according to this embodiment. Since the projection optical system 100e is a zoom lens (zooming optical system) having the zooming function, FIG. 11 illustrates the optical path diagram at a wide angle end when a projection distance is 1163 mm.

The projection optical system 100e includes, in order from the enlargement conjugate side to the reduction conjugate side, lens units B1, B2, B3, B4, B5, B6, B7, B8, B9, B10, and B11 respectively having negative, positive, positive, positive, negative, positive, negative, positive, negative, positive, and positive power. ST denotes an aperture stop. Of the lens units B1 to B11, seven lens units B5 to B11 form the first optical system 101, and four lens units B1 to B4 form the second optical system 102. The lens unit B1 includes the lens L1. The lens unit B2 includes the lenses L2 to L7. The lens unit B3 includes the lens L8. The lens unit B4 includes the lens L9. The lens unit B5 includes the lens L10. The lens unit B6 includes the lens L11. The lens unit B7 includes the lens L12. The lens unit B8 includes the lens L13. The lens unit B9 includes the lenses L14 and L15. The lens unit B10 includes the aperture stop ST and the lenses L16 to L20. The lens unit B11 includes the lens L21.

Zooming in this embodiment is performed by moving the five lens units B6, B7, B8, B9, and B10 forming the first optical system 101 in the optical axis direction of the first optical system 101 on different loci. The aperture stop ST is a part of the lens unit B10 and moves along with the lens unit B10 during zooming, and thus the zoom lens causes a change in F-number during zooming. In this embodiment, the zoom ratio is increased by making the number of lens units (lens units B5 to B9) moving during zooming larger than that in the first to fourth embodiments. However, five lens units B6, B7, B8, B9 and B10, which move during zooming, respectively have positive, negative, positive, negative, and positive power, and includes at least three lens units having positive, negative and positive power as the first to fourth embodiments.

Tables 6(A) to 6(C) show various values of the projection optical system 100e according to this embodiment. In this embodiment, the focal length of the lens unit B6 is 36.12 mm, the focal length of the lens unit B7 is −732.09 mm, and the focal length of the lens unit B8 is 86.05 mm. Thus, the projection optical system 100e satisfies the conditional expressions (2a), (3a), and (4a). Further, the focal length of the lens unit B10 is 111.89 mm, and even when the lens units B8 and B10 are used as a lens unit having positive power instead of the lens units B6 and B8, the conditional expressions (2a), (3a), and (4a) are satisfied. That is, the three lens units having positive, negative, and positive power need not be successive lens units in this order.

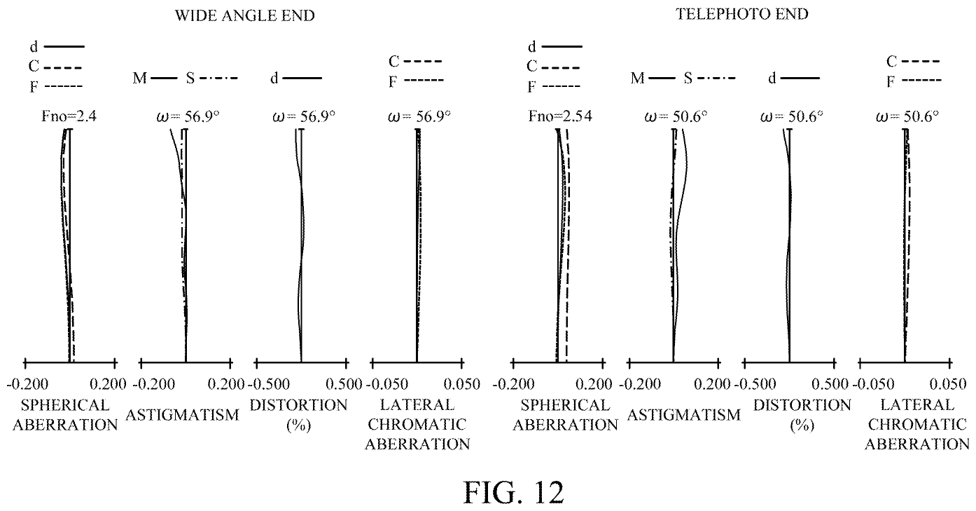

Referring now to FIG. 12, a description will be given of the optical performance of the projection optical system 100e. FIG. 12 is an aberration diagram of the projection optical system 100e at the wide angle end and the telephoto end when the projection distance is 1163 mm. All aberrations are well corrected at the wide angle end and the telephoto end, and the aberration fluctuations due to zooming are suppressed.

As described above, in the projection optical system 100e according to this embodiment, zooming is performed by moving the five lens units B6, B7, B8, B9 and B10 among the plurality of lens units forming the first optical system 101 along the optical axis OA. The five lens units B6, B7, B8, B9 and B10 include the three lens units (first to third lens units) having positive, negative, and positive power, further includes the fourth and fifth lens units, and can correct the astigmatism fluctuations and the distortion fluctuations during zooming. With such a configuration, it is possible to realize the zoom lens having the zooming function that suppresses the aberration fluctuations during zooming and achieves a small lens diameter and excellent optical performance while having a wide angle.

In this embodiment, as the first embodiment, the first optical system 101 includes a fixed lens unit (lens unit B5) that does not move during zooming and is arranged closest to the enlargement conjugate side, but may include the moving lens unit as the second to fifth embodiment. In this embodiment, for the sake of simplifying the configuration, for example, a moving lens unit (a part of a plurality of lens units) having a small moving amount may be used as the fixed lens unit under the condition that the optical performance standard is satisfied.

### Seventh Embodiment

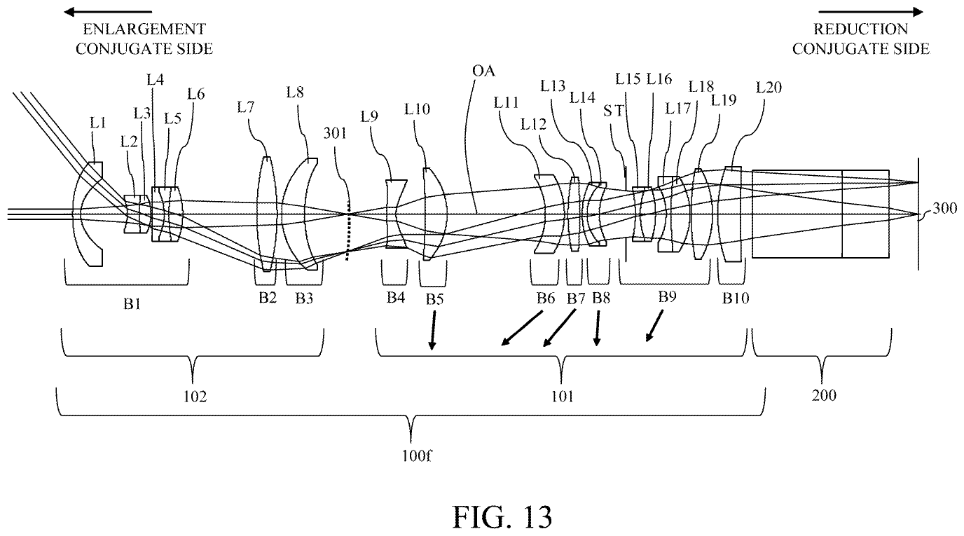

Referring now to FIG. 13, a description will be given of a projection optical system 100f according to a seventh embodiment. FIG. 13 is an optical path diagram of the projection optical system 100f according to this embodiment. Since the projection optical system 100f is a zoom lens (zooming optical system) having the zooming function, FIG. 13 illustrates the optical path diagram at a wide angle end when a projection distance is 1463 mm.

The projection optical system 100f includes, in order from the enlargement conjugate side to the reduction conjugate side, lens units B1, B2, B3, B4, B5, B6, B7, B8, B9, and B10 respectively having positive, positive, positive, negative, positive, negative, positive, negative, positive, and positive power. ST denotes an aperture stop. Of the lens units B1 to B10, seven lens units B4 to B10 form the first optical system 101, and three lens units B1 to B3 form the second optical system 102. The lens unit B1 includes the lenses L1 to L6. The lens unit B2 includes the lens L7. The lens unit B3 includes the lens L8. The lens unit B4 includes the lens L9. The lens unit B5 includes the lens L10. The lens unit B6 includes the lens L11. The lens unit B7 includes the lens L12. The lens unit B8 includes the lenses L13 and L14. The lens unit B9 includes the aperture stop ST and the lenses L15 to L19. The lens unit B10 includes the lens L20.

Zooming in this embodiment is performed by moving the five lens units B5, B6, B7, B8, and B9 forming the first optical system 101 in the optical axis direction of the first optical system 101 on different loci. The aperture stop ST is a part of the lens unit B9 and moves along with the lens unit B9 during zooming, and thus the zoom lens causes a change in F-number during zooming. In this embodiment, the zoom ratio is increased by making the number of lens units moving during zooming larger as the sixth embodiment. However, five lens units B5, B6, B7, B8, and B9, which move during zooming, respectively have positive, negative, positive, negative, and positive power, and includes at least three lens units having positive, negative and positive power as the first to sixth embodiments.

Tables 7(A) to 7(C) show various values of the projection optical system 100f according to this embodiment. In this embodiment, the focal length of the lens unit B5 is 35.05 mm, the focal length of the lens unit B6 is −9993.75 mm, and the focal length of the lens unit B7 is 81.45 mm. Thus, the projection optical system 100f satisfies the conditional expressions (2a), (3a), and (4a). Further, the focal length of the lens unit B8 is −947.79 mm, and even when the lens unit B8 is used as a lens unit having negative power instead of the lens unit B6, the conditional expressions (2a), (3a), and (4a) are satisfied. Additionally, the focal length of the lens unit B9 is 146.61 mm, and even when the lens units B7 and B9 are used as a lens unit having positive power instead of the lens units B5 and B7, the conditional expressions (2a), (3a), and (4a) are satisfied. That is, the three lens units having positive, negative, and positive power need not be successive lens units in this order.

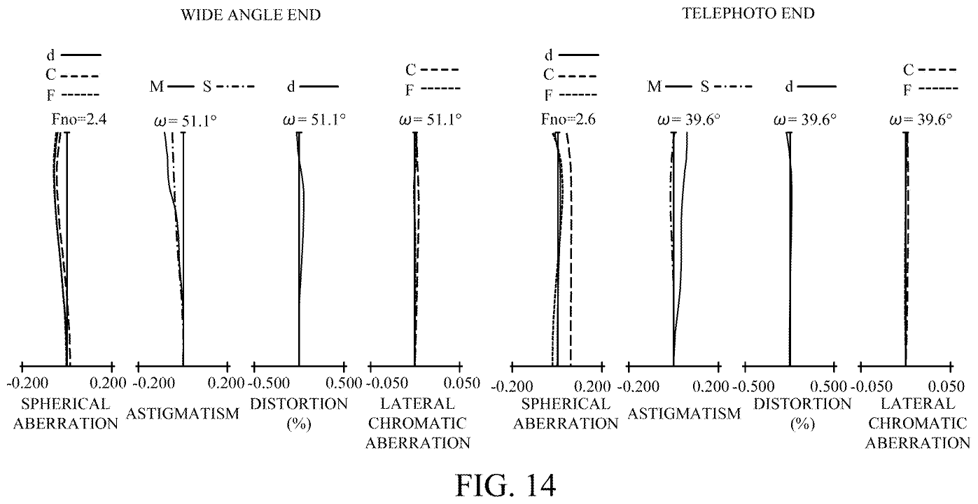

Referring now to FIG. 14, a description will be given of the optical performance of the projection optical system 100f. FIG. 14 is an aberration diagram of the projection optical system 100f at the wide angle end and the telephoto end when the projection distance is 1463 mm. All aberrations are well corrected at the wide angle end and the telephoto end, and the aberration fluctuations due to zooming are suppressed.

As described above, in the projection optical system 100f according to this embodiment, zooming is performed by moving the five lens units B5, B6, B7, B8, and B9 among the plurality of lens units forming the first optical system 101 along the optical axis OA. The five lens units B5, B6, B7, B8, and B9 include the three lens units (first to third lens units) having positive, negative, and positive power, further includes the fourth and fifth lens units, and can correct the astigmatism fluctuations and the distortion fluctuations during zooming. With such a configuration, it is possible to realize the zoom lens having the zooming function that suppresses the aberration fluctuations during zooming and achieves a small lens diameter and excellent optical performance while having a wide angle.

In this embodiment, as the first embodiment, the first optical system 101 includes a fixed lens unit (lens unit B5) that does not move during zooming and is arranged closest to the enlargement conjugate side, but may include the moving lens unit as the second to fifth embodiment. In this embodiment, for the sake of simplifying the configuration, for example, a moving lens unit (a part of a plurality of lens units) having a small moving amount may be used as the fixed lens unit under the condition that the optical performance standard is satisfied.

### [Image Projection Apparatus]

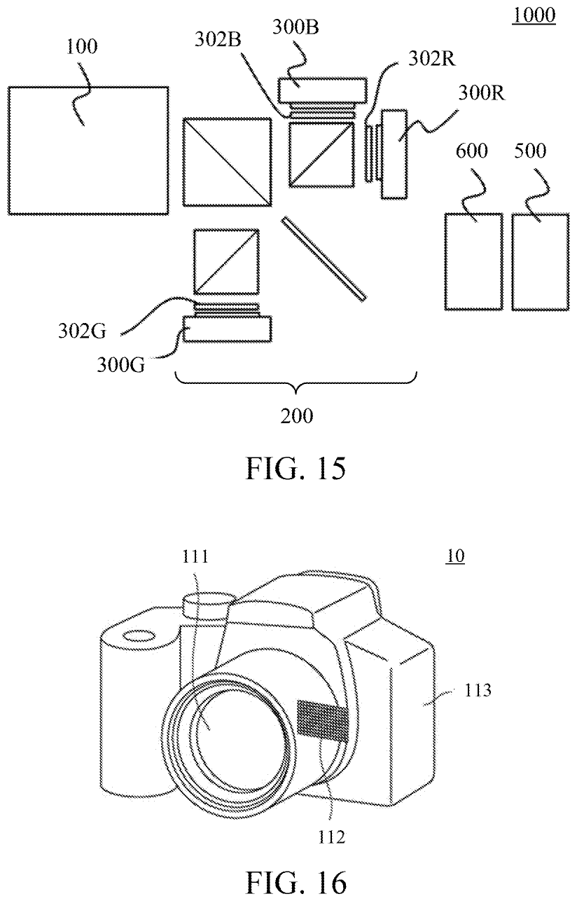

Referring now to FIG. 15, a description will be given of a projector (image projection apparatus) 1000 including the projection optical system (zoom lens) according to each embodiment. FIG. 15 is a schematic diagram of the projector 1000. The projector 1000 in FIG. 15 includes the projection optical system 100 according to the first embodiment as the zoom lens but may include another projection optical system. A reflective liquid crystal panel is used as a light modulation element of the projector 1000.

In FIG. 15, reference numeral 100 denotes the optical system (zoom lens), reference numeral 200 denotes a color separation/combination optical system, reference numeral 500 denotes a light source, and reference numeral 600 denotes an illumination optical system. The light source 500 emits light toward the illumination optical system 600. The illumination optical system 600 illuminates the light from the light source 500. The color separation/combination optical system 200 performs color separation and color combination on the illumination light from the illumination optical system 600. The projection optical system (zoom lens) 100 projects the combined light from the color separation/combination optical system 200.

In the color separation/combination optical system 200, reference numerals 301R, 301G and 301B are respectively light modulation elements for red, green, and blue (reflective liquid crystal panels for red, green, and blue) 300 (300R, 300G and 300B). Reference numerals 302R, 302G, and 302B are respectively wave plate units including red, green, and blue wave plates. In this embodiment, the light modulation elements 300R, 300G, and 300B are reflective liquid crystal panels but are not limited to this, and for example, may be a transmissive liquid crystal panel or DMD. Further, the present invention can be applied to any projector such as a single-plate type or a three-plate type regardless of the number of reflective liquid crystal panels.

### [Image Pickup Apparatus]

Referring now to FIG. 16, a description will be given of a digital still camera (image pickup apparatus 10) including the projection optical system (zoom lens) according to each embodiment as an imaging optical system. FIG. 16 is a schematic diagram of the image pickup apparatus 10 including the zoom lens according to each embodiment.

In FIG. 16, reference numeral 113 denotes a camera body, and reference numeral 111 is an imaging optical system configured by any of the zoom lenses described in the first to seventh embodiments. Reference numeral 112 denotes an image pickup element (photoelectric conversion element) such as a CCD sensor or a CMOS sensor which is built in the camera body 113 and photoelectrically converts an optical image formed by the imaging optical system 111. The camera body 113 may be a so-called single-lens reflex camera having a quick turn mirror or a so-called mirrorless camera having no quick turn mirror. When the zoom lens according to each embodiment is used the imaging optical system of the image pickup apparatus 10, the enlargement conjugate side and the reduction conjugate side respectively correspond to an object side and an image side.

According to each embodiment, it is possible to provide a wide angle and compact zoom lens having excellent optical characteristics, an image projection apparatus, and an image pickup apparatus. Moreover, according to the zoom lens of each embodiment, it is possible to secure a back focus and have excellent telecentricity.

TABLE 1(A)

| | Wide angle end | Telephoto end |
|---|---|---|
| f | −4.89 | −5.13 |
| Fno | 2.40 | 2.40 |
| ω | 69.35 | 68.43 |

| | |
|---|---|
| Zoom ratio | 1.05 |

| | Surface | Paraxial curvature | Surface | Refractive | Abbe |
|---|---|---|---|---|---|
| | number | radius r [mm] | Interval d [mm] | index n | number ν |
| | 1 | 55.35 | 2.00 | 1.892 | 37.13 |
| | 2 | 42.00 | 16.62 | — | — |
| ※ | 3 | 149.35 | 1.87 | 1.772 | 49.60 |
| | 4 | 34.58 | 5.38 | — | — |
| ※ | 5 | 35.19 | 2.00 | 1.583 | 59.39 |
| ※ | 6 | 14.72 | 21.15 | — | — |
| | 7 | −33.13 | 2.00 | 1.847 | 23.78 |
| | 8 | 26.78 | 4.47 | 1.593 | 68.62 |
| | 9 | −20.99 | 0.50 | — | — |
| | 10 | 126.93 | 6.72 | 1.883 | 40.77 |
| | 11 | −13.91 | 2.00 | 1.847 | 23.78 |
| | 12 | 36.71 | 6.67 | 1.593 | 68.62 |
| | 13 | −50.56 | 8.31 | — | — |
| | 14 | 132.90 | 10.08 | 1.808 | 22.76 |
| | 15 | −49.97 | 0.77 | — | — |
| ※ | 16 | 27.65 | 10.38 | 1.861 | 37.10 |
| ※ | 17 | 184.46 | 20.33 | — | — |
| ※ | 18 | 57.12 | 7.39 | 1.808 | 40.55 |
| ※ | 19 | 12.04 | variable | — | — |
| | 20 | −59.53 | 7.00 | 1.916 | 31.60 |
| | 21 | −31.72 | variable | — | — |
| | 22 | −34.31 | 7.30 | 1.764 | 48.49 |
| | 23 | −105.86 | variable | — | — |
| | 24 | 117.74 | 11.63 | 1.583 | 59.39 |
| ※ | 25 | −39.68 | variable | — | — |
| ST | 26 | ∞ | 19.33 | — | — |
| | 27 | 35.09 | 2.00 | 1.652 | 58.55 |
| | 28 | 15.67 | 6.40 | 1.808 | 22.76 |
| | 29 | 38.01 | 8.58 | — | — |
| | 30 | −49.86 | 2.55 | 1.847 | 23.78 |
| | 31 | 24.19 | 7.72 | 1.603 | 60.64 |
| | 32 | −23.90 | 3.83 | — | — |
| | 33 | −19.04 | 2.00 | 1.916 | 31.60 |
| | 34 | 55.08 | 7.49 | 1.678 | 55.34 |
| | 35 | −32.95 | 0.50 | — | — |
| | 36 | 104.59 | 8.84 | 1.439 | 94.66 |
| | 37 | −32.20 | 0.50 | — | — |
| | 38 | 73.66 | 6.49 | 1.497 | 81.55 |
| | 39 | −107.59 | 5.00 | — | — |
| | 40 | ∞ | 37.00 | 1.516 | 64.14 |
| | 41 | ∞ | 19.50 | 1.841 | 24.56 |
| | 42 | ∞ | 10.62 | — | — |

TABLE 1(B)

| | Surface Number | | | |
|---|---|---|---|---|
| | 3 | 5 | 6 | 16 |
| r | 149.35 | 35.19 | 14.72 | 27.65 |
| k | 4.21525 | 0.00000 | −0.65339 | 0.00000 |
| B4 | 1.54410E−05 | 3.42333E−07 | −4.72924E−05 | −6.05245E−06 |
| B6 | −2.45093E−08 | 8.05752E−08 | 3.82038E−07 | −1.07238E−08 |
| B8 | 3.19689E−11 | −2.55523E−10 | −1.33504E−09 | −9.32882E−12 |
| B10 | −2.64430E−14 | 3.88938E−13 | 9.39734E−13 | 2.64352E−15 |
| B12 | 1.29527E−17 | −2.55966E−16 | 1.57525E−15 | −7.87783E−18 |
| B14 | −2.76965E−21 | 0.00000E+00 | −2.09038E−18 | 0.00000E+00 |
| B16 | 0.00000E+00 | 0.00000E+00 | 0.00000E+00 | 0.00000E+00 |
| | Surface Number | | | |
| | 17 | 18 | 19 | 25 |
| r | 184.46 | 57.12 | 12.04 | −39.68 |
| k | 0.00000 | 0.00000 | −0.62839 | 0.00000 |
| B4 | 4.74855E−06 | 2.83476E−05 | −9.51802E−05 | 2.34201E−06 |
| B6 | −3.48077E−08 | −3.16489E−07 | 1.45068E−07 | 7.12962E−10 |
| B8 | 8.18481E−11 | 1.39135E−09 | −3.49355E−10 | −3.93659E−14 |
| B10 | −1.15043E−13 | −2.83461E−12 | 5.50468E−13 | 5.70452E−16 |
| B12 | 7.24481E−17 | 2.30650E−15 | −1.50234E−15 | 0.00000E+00 |
| B14 | 0.00000E+00 | 0.00000E+00 | 0.00000E+00 | 0.00000E+00 |
| B16 | 0.00000E+00 | 0.00000E+00 | 0.00000E+00 | 0.00000E+00 |

TABLE 1(C)

| | |
|---|---|
| Surface | Surface Interval d [mm] |

| Number | Wide angle end | Telephoto end |
|---|---|---|
| 19 | 25.06 | 19.21 |
| 21 | 7.54 | 1.41 |
| 23 | 6.30 | 14.02 |
| 25 | 30.29 | 34.56 |

TABLE 2(A)

| | Wide angle end | Telephoto end |
|---|---|---|
| f | −4.89 | −5.13 |
| Fno | 2.40 | 2.40 |
| ω | 69.35 | 68.42 |

| | |
|---|---|
| Zoom ratio | 1.05 |

| | Surface | Paraxial curvature | Surface | Refractive | Abbe |
|---|---|---|---|---|---|
| | number | radius r [mm] | Interval d [mm] | index n | number ν |
| | 1 | 54.71 | 2.00 | 1.916 | 31.60 |
| | 2 | 42.01 | 16.82 | — | — |
| ※ | 3 | 153.78 | 1.50 | 1.713 | 53.87 |
| | 4 | 34.31 | 5.00 | — | — |
| ※ | 5 | 35.00 | 2.00 | 1.583 | 59.39 |
| ※ | 6 | 14.69 | 20.90 | — | — |
| | 7 | −42.94 | 2.00 | 1.847 | 23.78 |
| | 8 | 23.11 | 4.18 | 1.593 | 68.62 |
| | 9 | −24.56 | 0.50 | — | — |
| | 10 | 398.13 | 6.62 | 1.883 | 40.81 |
| | 11 | −12.14 | 2.00 | 1.847 | 23.78 |
| | 12 | 39.34 | 6.96 | 1.593 | 68.62 |
| | 13 | −38.40 | 7.74 | — | — |
| | 14 | 306.57 | 9.95 | 1.808 | 22.76 |
| | 15 | −41.40 | 0.90 | — | — |
| ※ | 16 | 28.13 | 10.29 | 1.861 | 37.10 |
| ※ | 17 | 193.83 | variable | — | — |
| ※ | 18 | 48.68 | 6.21 | 1.808 | 40.55 |
| ※ | 19 | 11.83 | variable | — | — |
| | 20 | −52.84 | 6.34 | 1.850 | 30.05 |
| | 21 | −30.51 | variable | — | — |
| | 22 | −33.85 | 2.00 | 1.658 | 50.88 |
| | 23 | −97.36 | variable | — | — |
| ※ | 24 | 140.70 | 11.93 | 1.583 | 59.39 |
| ※ | 25 | −39.45 | variable | — | — |
| ST | 26 | ∞ | 20.05 | — | — |
| | 27 | 35.04 | 2.00 | 1.613 | 58.72 |
| | 28 | 15.53 | 6.28 | 1.808 | 22.76 |
| | 29 | 39.64 | 8.30 | — | — |
| | 30 | −47.69 | 2.79 | 1.847 | 23.78 |
| | 31 | 22.87 | 7.18 | 1.589 | 61.14 |
| | 32 | −23.74 | 3.84 | — | — |
| | 33 | −18.84 | 2.00 | 1.916 | 31.60 |
| | 34 | 52.74 | 7.34 | 1.697 | 55.53 |
| | 35 | −34.04 | 0.50 | — | — |
| | 36 | 122.34 | 8.39 | 1.439 | 94.66 |
| | 37 | −33.01 | 0.50 | — | — |
| | 38 | 65.85 | 7.04 | 1.497 | 81.55 |
| | 39 | −90.46 | 5.00 | — | — |
| | 40 | ∞ | 37.00 | 1.516 | 64.14 |
| | 41 | ∞ | 19.50 | 1.841 | 24.56 |
| | 42 | ∞ | 10.62 | — | — |

TABLE 2(B)

| | Surface Number | | | | |
|---|---|---|---|---|---|
| | 3 | 5 | 6 | 16 | 17 |
| r | 153.78 | 35.00 | 14.69 | 28.13 | 193.83 |
| k | 2.34326 | 0.00000 | −0.65264 | 0.00000 | 0.00000 |
| B4 | 1.69708E−05 | −3.97342E−07 | −4.48487E−05 | −6.02438E−06 | 3.11269E−06 |
| B6 | −3.15993E−08 | 1.02521E−07 | 3.67458E−07 | −9.35453E−09 | −1.98777E−08 |
| B8 | 4.68982E−11 | −3.41016E−10 | −1.31376E−09 | −2.45708E−12 | 3.59358E−11 |
| B10 | −4.28040E−14 | 5.36401E−13 | 9.83526E−13 | −2.47419E−14 | −5.72171E−14 |
| B12 | 2.22968E−17 | −3.49424E−16 | 1.42314E−15 | 1.73096E−17 | 4.33900E−17 |
| B14 | −4.99316E−21 | 0.00000E+00 | −1.97803E−18 | 0.00000E+00 | 0.00000E+00 |
| B16 | 0.00000E+00 | 0.00000E+00 | 0.00000E+00 | 0.00000E+00 | 0.00000E+00 |

Surface Number

| | 18 | 19 | 24 | 25 |
|---|---|---|---|---|
| r | 48.68 | 11.83 | 140.70 | −39.45 |
| k | 0.00000 | −0.62764 | 0.00000 | 0.00000 |
| B4 | 4.42339E−05 | −6.41607E−05 | 1.35543E−06 | 2.93967E−06 |
| B6 | −4.21752E−07 | −1.71645E−07 | −1.20188E−09 | 2.61170E−10 |
| B8 | 1.63254E−09 | 9.76359E−10 | 5.49122E−14 | 4.03202E−14 |
| B10 | −3.05803E−12 | −2.49712E−12 | −3.24249E−16 | −1.62480E−16 |
| B12 | 2.38382E−15 | 1.57452E−15 | 0.00000E+00 | 0.00000E+00 |
| B14 | 0.00000E+00 | 0.00000E+00 | 0.00000E+00 | 0.00000E+00 |
| B16 | 0.00000E+00 | 0.00000E+00 | 0.00000E+00 | 0.00000E+00 |

TABLE 2(C)

| | |
|---|---|
| Surface | Surface Interval d [mm] |

| Number | Wide angle end | Telephoto end |
|---|---|---|
| 17 | 20.72 | 20.63 |
| 19 | 24.68 | 18.81 |
| 21 | 7.97 | 1.44 |
| 23 | 10.31 | 18.60 |
| 25 | 34.26 | 38.47 |

TABLE 3(A)

| | Wide angle end | Telephoto end |
|---|---|---|
| f | −5.69 | −6.26 |
| Fno | 2.40 | 2.40 |
| ω | 66.37 | 64.33 |

| | |
|---|---|
| Zoom ratio | 1.10 |

| | Surface | Paraxial curvature | Surface | Refractive | Abbe |
|---|---|---|---|---|---|
| | number | radius r [mm] | Interval d [mm] | index n | number ν |
| ※ | 1 | 71.72 | 2.00 | 1.772 | 49.60 |
| | 2 | 35.00 | 12.30 | — | — |
| ※ | 3 | 68.79 | 4.02 | 1.583 | 59.39 |
| ※ | 4 | 14.66 | 20.86 | — | — |
| | 5 | −26.19 | 2.06 | 1.847 | 23.78 |
| | 6 | 36.08 | 4.57 | 1.593 | 68.62 |
| | 7 | −17.60 | 0.50 | — | — |
| | 8 | 63.54 | 6.01 | 1.816 | 46.62 |
| | 9 | −18.49 | 2.00 | 1.847 | 23.78 |
| | 10 | 34.25 | 5.77 | 1.593 | 68.62 |
| | 11 | −82.94 | 7.53 | — | — |
| | 12 | 100.22 | 9.35 | 1.808 | 22.76 |
| | 13 | −47.91 | 0.75 | — | — |
| ※ | 14 | 27.20 | 10.00 | 1.861 | 37.10 |
| ※ | 15 | 281.99 | variable | — | — |
| ※ | 16 | −78.60 | 4.50 | 1.583 | 59.39 |
| ※ | 17 | 15.18 | variable | — | — |
| | 18 | −87.32 | 6.85 | 1.667 | 48.33 |
| | 19 | −33.89 | variable | — | — |
| | 20 | −24.45 | 9.50 | 1.883 | 40.77 |
| | 21 | −30.55 | variable | — | — |
| ※ | 22 | 53.00 | 10.60 | 1.583 | 59.39 |
| ※ | 23 | −176.68 | variable | — | — |
| ST | 24 | ∞ | 12.21 | — | — |
| | 25 | 38.13 | 2.00 | 1.750 | 35.33 |
| | 26 | 13.51 | 6.69 | 1.808 | 22.76 |
| | 27 | 53.60 | 8.42 | — | — |
| | 28 | −25.84 | 2.00 | 1.847 | 23.78 |
| | 29 | 45.32 | 6.76 | 1.642 | 58.37 |
| | 30 | −19.96 | 3.71 | — | — |
| | 31 | −17.65 | 2.00 | 1.916 | 31.60 |
| | 32 | −953.83 | 6.31 | 1.697 | 55.53 |
| | 33 | −29.14 | 0.50 | — | — |
| | 34 | 375.33 | 8.29 | 1.439 | 94.66 |
| | 35 | −35.40 | 0.50 | — | — |
| | 36 | 54.55 | 7.31 | 1.497 | 81.55 |
| | 37 | −107.69 | 5.00 | — | — |
| | 38 | ∞ | 37.00 | 1.516 | 64.14 |
| | 39 | ∞ | 19.50 | 1.841 | 24.56 |
| | 40 | ∞ | 10.12 | — | — |

TABLE 3(B)

| | Surface Number | | | | |
|---|---|---|---|---|---|
| | 1 | 3 | 4 | 14 | 15 |
| r | 71.72 | 68.79 | 14.66 | 27.20 | 281.99 |
| k | 0.00000 | 0.00000 | −0.66015 | 0.00000 | 0.00000 |
| B4 | 1.34349E−06 | 2.07806E−05 | −4.32193E−05 | −8.43849E−06 | 6.59828E−06 |
| B6 | 1.23720E−11 | −2.44583E−08 | 2.77309E−07 | −8.68969E−10 | −1.22493E−08 |
| B8 | −2.97885E−13 | 1.93963E−11 | −1.35302E−09 | −3.39357E−11 | −7.37415E−12 |
| B10 | 2.22518E−16 | 7.08097E−15 | 2.33529E−12 | 3.40109E−14 | 0.00000E+00 |
| B12 | −4.00745E−20 | −2.19914E−17 | −1.52309E−15 | −7.51111E−17 | 0.00000E+00 |
| B14 | 0.00000E+00 | 0.00000E+00 | 0.00000E+00 | 0.00000E+00 | 0.00000E+00 |
| B16 | 0.00000E+00 | 0.00000E+00 | 0.00000E+00 | 0.00000E+00 | 0.00000E+00 |

Surface Number

| | 16 | 17 | 22 | 23 |
|---|---|---|---|---|
| r | −78.60 | 15.18 | 53.00 | −176.68 |
| k | 0.00000 | −0.70173 | 0.00000 | 0.00000 |
| B4 | −4.60342E−05 | −1.60733E−04 | 2.13753E−07 | 1.61118E−06 |
| B6 | 1.58241E−08 | 6.25308E−07 | 3.87333E−09 | 4.95785E−09 |
| B8 | 1.00462E−09 | −1.80716E−09 | −1.22342E−11 | −1.74645E−11 |
| B10 | −4.23297E−12 | 2.82705E−12 | 2.03316E−14 | 3.54838E−14 |
| B12 | 5.60174E−15 | −1.80002E−15 | −1.52292E−17 | −3.84093E−17 |
| B14 | 0.00000E+00 | 0.00000E+00 | 0.00000E+00 | 1.33563E−20 |
| B16 | 0.00000E+00 | 0.00000E+00 | 0.00000E+00 | 0.00000E+00 |

TABLE 3(C)

| | |
|---|---|
| Surface | Surface Interval d [mm] |

| Number | Wide angle end | Telephoto end |
|---|---|---|
| 15 | 19.40 | 19.13 |
| 17 | 10.07 | 12.85 |
| 19 | 29.40 | 6.02 |
| 21 | 0.50 | 20.45 |
| 23 | 54.77 | 55.68 |

TABLE 4(A)

| | Wide angle end | Telephoto end |
|---|---|---|
| f | −7.10 | −7.81 |
| Fno | 2.40 | 2.40 |
| ω | 61.35 | 59.03 |

| | |
|---|---|
| Zoom ratio | 1.10 |

| | Surface | Paraxial curvature | Surface | Refractive | Abbe |
|---|---|---|---|---|---|
| | number | radius r [mm] | Interval d [mm] | index n | number ν |
| | 1 | 47.04 | 2.60 | 1.923 | 20.88 |
| | 2 | 37.87 | 11.72 | — | — |
| ※ | 3 | 99.31 | 3.78 | 1.772 | 49.60 |
| | 4 | 29.47 | 1.00 | — | — |
| ※ | 5 | 29.76 | 2.54 | 1.583 | 59.39 |
| ※ | 6 | 14.48 | 22.17 | — | — |
| | 7 | −19.47 | 2.00 | 1.847 | 23.78 |
| | 8 | 32.93 | 4.72 | 1.593 | 68.62 |
| | 9 | −15.47 | 0.50 | — | — |
| | 10 | 96.84 | 6.15 | 1.883 | 40.81 |
| | 11 | −14.96 | 2.00 | 1.847 | 23.78 |
| | 12 | 34.83 | 6.28 | 1.593 | 68.62 |
| | 13 | −44.21 | 14.67 | — | — |
| | 14 | 872.56 | 8.44 | 1.808 | 22.76 |
| | 15 | −47.12 | 1.03 | — | — |
| ※ | 16 | 26.16 | 11.46 | 1.861 | 37.10 |
| ※ | 17 | 91.00 | variable | — | — |
| ※ | 18 | 67.86 | 3.71 | 1.808 | 40.55 |
| ※ | 19 | 13.55 | variable | — | — |
| | 20 | −78.05 | 9.50 | 1.855 | 24.80 |
| | 21 | −30.56 | variable | — | — |
| | 22 | −66.51 | 2.01 | 1.589 | 61.14 |
| | 23 | −1260.14 | variable | — | — |
| | 24 | 251.56 | 6.56 | 1.697 | 55.53 |
| | 25 | −59.22 | variable | — | — |
| ST | 26 | ∞ | 1.95 | — | — |
| | 27 | 48.92 | 4.00 | 1.673 | 38.26 |
| | 28 | 19.72 | 8.20 | 1.808 | 22.76 |
| | 29 | 83.50 | 8.83 | — | — |
| | 30 | −57.28 | 2.03 | 1.847 | 23.78 |
| | 31 | 32.24 | 8.84 | 1.713 | 53.87 |
| | 32 | −32.72 | 3.59 | — | — |
| | 33 | −27.20 | 2.04 | 1.916 | 31.60 |
| | 34 | 51.97 | 8.20 | 1.589 | 61.14 |
| | 35 | −46.12 | 0.53 | — | — |
| | 36 | 88.87 | 7.80 | 1.497 | 81.55 |
| | 37 | −61.29 | 0.50 | — | — |
| | 38 | 67.38 | 6.84 | 1.487 | 70.24 |
| | 39 | −178.37 | 5.00 | — | — |
| | 40 | ∞ | 37.00 | 1.516 | 64.14 |
| | 41 | ∞ | 19.50 | 1.841 | 24.56 |
| | 42 | ∞ | 18.21 | — | — |

TABLE 4(C)

| | |
|---|---|
| Surface | Surface Interval d [mm] |

| Number | Wide angle end | Telephoto end |
|---|---|---|
| 17 | 22.90 | 22.78 |
| 19 | 17.51 | 13.84 |
| 21 | 37.59 | 0.50 |
| 23 | 0.50 | 20.02 |
| 25 | 35.25 | 56.61 |

TABLE 5(A)

| | Wide angle end | Telephoto end |
|---|---|---|
| f | −8.51 | −10.73 |
| Fno | 2.40 | 2.40 |
| ω | 56.88 | 50.61 |

| | |
|---|---|
| Zoom ratio | 1.26 |

| | Surface | Paraxial curvature | Surface | Refractive | Abbe |
|---|---|---|---|---|---|
| | number | radius r [mm] | Interval d [mm] | index n | number ν |
| | 1 | 42.50 | 2.00 | 1.806 | 40.93 |
| | 2 | 30.31 | 23.13 | — | — |
| ※ | 3 | 36.53 | 2.01 | 1.583 | 59.39 |
| ※ | 4 | 12.43 | 20.30 | — | — |
| | 5 | −15.64 | 2.25 | 1.808 | 22.76 |
| | 6 | 63.53 | 4.91 | 1.593 | 68.62 |
| | 7 | −14.82 | 0.50 | — | — |
| | 8 | 226.75 | 5.28 | 1.892 | 37.13 |
| | 9 | −18.42 | 2.00 | 1.847 | 23.78 |
| | 10 | 57.57 | 5.72 | 1.593 | 68.62 |
| | 11 | −31.48 | 27.99 | — | — |
| | 12 | 75.60 | 7.73 | 1.808 | 22.76 |
| | 13 | −228.10 | 1.77 | — | — |
| ※ | 14 | 27.28 | 10.41 | 1.861 | 37.10 |
| ※ | 15 | 76.31 | variable | — | — |
| ※ | 16 | 43.53 | 2.00 | 1.808 | 40.55 |
| ※ | 17 | 12.59 | variable | — | — |
| | 18 | −92.62 | 9.50 | 1.916 | 31.60 |
| | 19 | −26.28 | variable | — | — |
| | 20 | −21.91 | 9.50 | 1.772 | 49.60 |
| | 21 | −26.19 | variable | — | — |
| | 22 | 67.48 | 4.95 | 1.835 | 42.74 |
| | 23 | −578.95 | variable | — | — |
| | 24 | 108.27 | 2.00 | 1.852 | 40.78 |
| | 25 | 26.46 | 4.95 | 1.946 | 17.98 |
| | 26 | 57.68 | variable | — | — |
| ST | 27 | ∞ | 3.42 | — | — |
| | 28 | −146.18 | 2.00 | 1.847 | 23.78 |
| | 29 | 25.61 | 8.09 | 1.678 | 55.34 |
| | 30 | −34.00 | 4.45 | — | — |
| | 31 | −23.68 | 2.00 | 1.855 | 24.80 |
| | 32 | 78.18 | 8.62 | 1.623 | 58.17 |
| | 33 | −37.09 | 0.50 | — | — |
| | 34 | 124.28 | 10.42 | 1.439 | 94.66 |
| | 35 | −36.24 | 0.50 | — | — |
| | 36 | 56.61 | 5.94 | 1.497 | 81.55 |
| | 37 | 265.29 | 5.00 | — | — |
| | 38 | ∞ | 37.00 | 1.516 | 64.14 |
| | 39 | ∞ | 19.50 | 1.841 | 24.56 |
| | 40 | ∞ | 13.14 | — | — |

TABLE 5(B)

| | Surface Number | | |
|---|---|---|---|
| | 3 | 4 | 14 |
| r | 36.53 | 12.43 | 27.28 |
| k | 0.00000 | −0.60097 | 0.00000 |
| B4 | 2.56906E−05 | −2.36398E−05 | −4.94392E−06 |
| B6 | −5.51110E−08 | 2.82071E−08 | 3.67828E−10 |
| B8 | 2.20732E−10 | −1.38627E−10 | −3.86811E−12 |
| B10 | −4.33438E−13 | −9.67046E−13 | −5.65318E−15 |
| B12 | 4.91011E−16 | 0.00000E+00 | 0.00000E+00 |
| B14 | 0.00000E+00 | 0.00000E+00 | 0.00000E+00 |
| B16 | 0.00000E+00 | 0.00000E+00 | 0.00000E+00 |
| | Surface Number | | |
| | 15 | 16 | 17 |
| r | 76.31 | 43.53 | 12.59 |
| k | 0.00000 | 0.00000 | −1.10738 |
| B4 | −1.90072E−06 | −1.43993E−04 | −1.70063E−04 |
| B6 | 1.36324E−08 | 4.32458E−07 | 6.75603E−07 |
| B8 | −2.99277E−11 | −8.08465E−10 | −1.12659E−09 |
| B10 | 2.95598E−14 | 0.00000E+00 | −6.21375E−13 |
| B12 | 0.00000E+00 | 0.00000E+00 | 0.00000E+00 |
| B14 | 0.00000E+00 | 0.00000E+00 | 0.00000E+00 |
| B16 | 0.00000E+00 | 0.00000E+00 | 0.00000E+00 |

TABLE 5(C)

| | |
|---|---|
| Surface | Surface Interval d [mm] |

| Number | Wide angle end | Telephoto end |
|---|---|---|
| 15 | 30.22 | 30.30 |
| 17 | 11.43 | 11.74 |
| 19 | 25.16 | 9.71 |
| 21 | 1.00 | 1.26 |
| 23 | 1.21 | 24.87 |
| 26 | 16.13 | 7.27 |

TABLE 6(A)

| | Wide angle end | Telephoto end |
|---|---|---|
| f | −8.51 | −10.73 |
| Fno | 2.40 | 2.54 |
| ω | 56.88 | 50.61 |

| | |
|---|---|
| Zoom ratio | 1.26 |

| | Surface | Paraxial curvature | Surface | Refractive | Abbe |
|---|---|---|---|---|---|
| | number | radius r [mm] | Interval d [mm] | index n | number ν |
| | 1 | 42.55 | 2.00 | 1.806 | 40.93 |
| | 2 | 30.25 | 23.11 | — | — |
| ※ | 3 | 40.45 | 2.00 | 1.583 | 59.39 |
| ※ | 4 | 12.91 | 19.29 | — | — |
| | 5 | −15.93 | 2.00 | 1.808 | 22.76 |
| | 6 | 84.98 | 4.74 | 1.593 | 68.62 |
| | 7 | −14.84 | 0.50 | — | — |
| | 8 | 165.18 | 5.72 | 1.892 | 37.13 |
| | 9 | −15.38 | 2.00 | 1.847 | 23.78 |
| | 10 | 40.01 | 5.88 | 1.593 | 68.62 |
| | 11 | −35.79 | 23.71 | — | — |
| | 12 | 90.70 | 7.99 | 1.808 | 22.76 |
| | 13 | −119.88 | 0.86 | — | — |
| ※ | 14 | 27.59 | 10.32 | 1.861 | 37.10 |
| ※ | 15 | 86.82 | 30.93 | — | — |
| ※ | 16 | 49.01 | 2.37 | 1.808 | 40.55 |
| ※ | 17 | 12.58 | variable | — | — |
| | 18 | −138.77 | 5.80 | 1.916 | 31.60 |
| | 19 | −27.41 | variable | — | — |
| | 20 | −20.27 | 9.01 | 1.772 | 49.60 |
| | 21 | −25.10 | variable | — | — |
| | 22 | 87.00 | 4.53 | 1.835 | 42.74 |
| | 23 | −414.19 | variable | — | — |
| | 24 | 40.18 | 2.00 | 1.852 | 40.78 |
| | 25 | 21.10 | 4.83 | 1.946 | 17.98 |
| | 26 | 33.61 | variable | — | — |
| ST | 27 | ∞ | 3.19 | — | — |
| | 28 | −329.43 | 2.00 | 1.847 | 23.78 |
| | 29 | 29.21 | 6.62 | 1.678 | 55.34 |
| | 30 | −64.59 | 4.93 | — | — |
| | 31 | −27.49 | 2.00 | 1.855 | 24.80 |
| | 32 | 79.77 | 8.42 | 1.623 | 58.17 |
| | 33 | −33.52 | 0.50 | — | — |
| | 34 | 89.56 | 9.10 | 1.439 | 94.66 |
| | 35 | −42.88 | variable | — | — |
| | 36 | 58.51 | 5.29 | 1.497 | 81.55 |
| | 37 | 213.32 | 5.00 | — | — |
| | 38 | ∞ | 37.00 | 1.516 | 64.14 |
| | 39 | ∞ | 19.50 | 1.841 | 24.56 |
| | 40 | ∞ | 11.56 | — | — |

TABLE 6(B)

| | Surface Number | | |
|---|---|---|---|
| | 3 | 4 | 14 |
| r | 40.45 | 12.91 | 27.59 |
| k | 0.00000 | −0.55092 | 0.00000 |
| B4 | 3.00636E−05 | −2.68398E−05 | −5.72942E−06 |
| B6 | −7.00024E−08 | 4.06663E−08 | −3.66132E−10 |
| B8 | 2.93783E−10 | −4.96077E−11 | −3.14018E−12 |
| B10 | −6.04820E−13 | −1.34360E−12 | −3.15566E−15 |
| B12 | 6.85884E−16 | 0.00000E+00 | 0.00000E+00 |
| B14 | 0.00000E+00 | 0.00000E+00 | 0.00000E+00 |
| B16 | 0.00000E+00 | 0.00000E+00 | 0.00000E+00 |

| | Surface Number | | |
|---|---|---|---|
| | 15 | 16 | 17 |
| r | 86.82 | 49.01 | 12.58 |
| k | 0.00000 | 0.00000 | −1.05348 |
| B4 | −2.24617E−06 | −1.25823E−04 | −1.68721E−04 |
| B6 | 1.08983E−08 | 4.17605E−07 | 7.08459E−07 |
| B8 | −1.94537E−11 | −6.90436E−10 | −1.34338E−09 |
| B10 | 2.04614E−14 | 0.00000E+00 | 0.00000E+00 |
| B12 | 0.00000E+00 | 0.00000E+00 | 0.00000E+00 |
| B14 | 0.00000E+00 | 0.00000E+00 | 0.00000E+00 |
| B16 | 0.00000E+00 | 0.00000E+00 | 0.00000E+00 |

TABLE 6(C)

| | |
|---|---|
| Surface | Surface Interval d [mm] |

| Number | Wide angle end | Telephoto end |
|---|---|---|
| 17 | 12.76 | 13.03 |
| 19 | 10.19 | 8.14 |
| 21 | 19.80 | 1.00 |
| 23 | 14.93 | 30.35 |
| 26 | 10.16 | 4.92 |
| 35 | 0.50 | 10.91 |

TABLE 7(A)

| | Wide angle end | Telephoto end |
|---|---|---|
| f | −10.54 | −15.80 |
| Fno | 2.40 | 2.60 |
| ω | 51.09 | 39.62 |

| | |
|---|---|
| Zoom ratio | 1.50 |

| | Surface | Paraxial curvature | Surface | Refractive | Abbe |
|---|---|---|---|---|---|
| | number | radius r [mm] | Interval d [mm] | index n | number ν |
| ※ | 1 | 50.98 | 3.32 | 1.583 | 59.39 |
| ※ | 2 | 13.00 | 19.33 | — | — |
| | 3 | −17.36 | 4.97 | 1.808 | 22.76 |
| | 4 | 72.70 | 4.85 | 1.593 | 68.62 |
| | 5 | −17.52 | 0.50 | — | — |
| | 6 | 638.02 | 4.93 | 1.883 | 40.77 |
| | 7 | −21.57 | 2.00 | 1.847 | 23.78 |
| | 8 | 63.95 | 5.74 | 1.593 | 68.63 |
| | 9 | −29.66 | 30.62 | — | — |
| | 10 | 99.62 | 8.37 | 1.808 | 22.76 |
| | 11 | −99.42 | 1.86 | — | — |
| ※ | 12 | 28.80 | 9.50 | 1.861 | 37.10 |
| ※ | 13 | 47.25 | 33.98 | — | — |
| ※ | 14 | 35.33 | 3.91 | 1.808 | 40.55 |
| ※ | 15 | 12.03 | variable | — | — |
| | 16 | −222.76 | 9.06 | 1.892 | 37.13 |
| | 17 | −28.08 | variable | — | — |
| | 18 | −28.58 | 7.84 | 1.497 | 81.55 |
| | 19 | −31.37 | variable | — | — |
| | 20 | 76.97 | 4.86 | 1.697 | 55.53 |
| | 21 | −213.57 | variable | — | — |
| | 22 | 29.96 | 2.00 | 1.892 | 37.13 |
| | 23 | 16.66 | 5.11 | 1.946 | 17.98 |
| | 24 | 24.45 | variable | — | — |
| ST | 25 | ∞ | 3.98 | — | — |
| | 26 | −46.94 | 2.00 | 1.847 | 23.78 |
| | 27 | 29.46 | 6.36 | 1.603 | 60.64 |
| | 28 | −34.87 | 4.40 | — | — |
| | 29 | −22.70 | 2.00 | 1.916 | 31.60 |
| | 30 | 151.37 | 7.82 | 1.764 | 48.49 |
| | 31 | −28.91 | 0.50 | — | — |
| | 32 | 104.94 | 8.87 | 1.439 | 94.66 |
| | 33 | −38.59 | variable | — | — |
| | 34 | 60.25 | 9.50 | 1.497 | 81.55 |
| | 35 | 1078.08 | 5.00 | — | — |
| | 36 | ∞ | 37.00 | 1.516 | 64.14 |
| | 37 | ∞ | 19.50 | 1.841 | 24.56 |
| | 38 | ∞ | 11.94 | — | — |

TABLE 7(B)

| | Surface Number | | |
|---|---|---|---|
| | 1 | 2 | 12 |
| r | 50.98 | 13.00 | 28.80 |
| k | 0.00000 | −0.57804 | 0.00000 |
| B4 | 7.26364E−06 | −2.87844E−05 | −4.30723E−06 |
| B6 | 1.32443E−08 | 4.87171E−08 | 2.38273E−09 |
| B8 | −3.15997E−11 | 4.41349E−10 | −2.62989E−13 |
| B10 | 3.59509E−14 | −2.49469E−12 | 1.28324E−16 |
| B12 | −9.34466E−18 | 0.00000E+00 | 0.00000E+00 |
| B14 | 0.00000E+00 | 0.00000E+00 | 0.00000E+00 |
| B16 | 0.00000E+00 | 0.00000E+00 | 0.00000E+00 |
| | Surface Number | | |
| | 13 | 14 | 15 |
| r | 47.25 | 35.33 | 12.03 |
| k | 0.00000 | 0.00000 | −1.12016 |
| B4 | −4.61332E−06 | −1.21765E−04 | −1.62617E−04 |
| B6 | 1.93888E−08 | 2.59278E−07 | 6.14843E−07 |
| B8 | −1.70375E−11 | −3.60425E−10 | −1.42314E−09 |
| B10 | 1.43948E−14 | 0.00000E+00 | 1.47128E−12 |
| B12 | 0.00000E+00 | 0.00000E+00 | 0.00000E+00 |
| B14 | 0.00000E+00 | 0.00000E+00 | 0.00000E+00 |
| B16 | 0.00000E+00 | 0.00000E+00 | 0.00000E+00 |

TABLE 7(C)

| | |
|---|---|
| Surface | Surface Interval d [mm] |

| Number | Wide angle end | Telephoto end |
|---|---|---|
| 15 | 12.08 | 11.76 |
| 17 | 40.72 | 7.18 |
| 19 | 1.50 | 1.50 |
| 21 | 1.00 | 27.21 |
| 24 | 10.94 | 5.12 |
| 33 | 2.11 | 15.58 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-142672, filed on Aug. 2, 2019 which is hereby incorporated by reference herein in its entirety.

What is claimed is:

1. A zoom lens comprising, in order from a reduction conjugate side to an enlargement conjugate side, a first optical system having a positive refractive power, and a second optical system having positive refractive power,
wherein the second optical system reimages an intermediate image formed by the first optical system,
wherein the second optical system does not move during zooming,
wherein the first optical system includes a first lens unit that moves during zooming and has a positive refractive power, a second lens unit that moves during zooming and has a negative refractive power, and a third lens unit that moves during zooming and has a positive refractive power, and
wherein a distance between adjacent lens units in the first optical system changes during zooming.

2. The zoom lens according to claim 1, wherein the following conditional expressions are satisfied:
$$- 1.5 < \frac{fp 1}{fm} < 0 \\ - 1.5 < \frac{fp 2}{fm} < 0$$
where fm is a focal length of the second lens unit, fp1 is a focal length of the first lens unit, and fp2 is a focal length of the third lens unit.

3. The zoom lens according to claim 2, wherein the following conditional expressions are satisfied:
$$- 1 < \frac{fp 1}{fm} < - 0.003 \\ - 1 < \frac{fp 2}{fm} < - 0.003 .$$

4. The zoom lens according to claim 2, wherein the following conditional expression is satisfied:
$$0 .3 < \frac{fp 1}{fp 2} < 3.3 .$$

5. The zoom lens according to claim 4, wherein the following conditional expression is satisfied:
$$0.4 < \frac{fp 1}{fp 2} < 2.5 .$$

6. The zoom lens according to claim 1, wherein the first lens unit, the second lens unit, and the third lens unit are arranged in order from the enlargement conjugate side to the reduction conjugate side.

7. The zoom lens according to claim 1, wherein the second lens unit, the first lens unit, and the third lens unit are arranged in order from the enlargement conjugate side to the reduction conjugate side.

8. The zoom lens according to claim 1, wherein the first lens unit, the third lens unit, and the second lens unit are arranged in order from the enlargement conjugate side to the reduction conjugate side.

9. The zoom lens according to claim 1, wherein the first lens unit, the second lens unit, and the third lens unit are successively arranged.

10. The zoom lens according to claim 1, wherein the first lens optical system includes a fixed lens unit that is arranged closest to the enlargement conjugate side and does not move during zooming.

11. The zoom lens according to claim 1, wherein a lens unit arranged closest to the enlargement conjugate side in the first optical system moves during zooming.

12. The zoom lens according to claim 1, wherein a lens unit moving during zooming in the first optical system includes the first lens unit, the second lens unit, and the third lens unit.

13. The zoom lens according to claim 12, wherein the first optical system further includes a fourth lens unit moving during zooming.

14. The zoom lens according to claim 13, wherein the first optical system further includes a fifth lens unit moving during zooming.

15. The zoom lens according to claim 1, wherein the first optical system includes, in order from the enlargement conjugate side to the reduction conjugate side, five lens units respectively having negative, positive, negative, positive, and positive refractive power.

16. The zoom lens according to claim 1, wherein the first optical system includes, in order from the enlargement conjugate side to the reduction conjugate side, six lens units respectively having negative, positive, negative, positive, negative, and positive refractive power.

17. The zoom lens according to claim 1, wherein the first optical system includes, in order from the enlargement conjugate side to the reduction conjugate side, seven lens units respectively having negative, positive, negative, positive, negative, positive, and positive refractive power.

18. An image projection apparatus comprising:
a light source;
a light modulation element that modulates light from the light source; and
a zoom lens that projects light from the light modulation element,
wherein the zoom lens includes, in order from a reduction conjugate side to an enlargement conjugate side, a first optical system having a positive refractive power, and a second optical system having positive refractive power,
wherein the second optical system reimages an intermediate image formed by the first optical system,
wherein the second optical system does not move during zooming,
wherein the first optical system includes a first lens unit that moves during zooming and has a positive refractive power, a second lens unit that moves during zooming and has a negative refractive power, and a third lens unit that moves during zooming and has a positive refractive power, and
wherein a distance between adjacent lens units in the first optical system changes during zooming.

19. An image pickup apparatus comprising:
a zoom lens; and
an image pickup element that receives an image formed by the zoom lens,
wherein the zoom lens includes, in order from a reduction conjugate side to an enlargement conjugate side, a first optical system having a positive refractive power, and a second optical system having positive refractive power,
wherein the second optical system reimages an intermediate image formed by the first optical system,
wherein the second optical system does not move during zooming,
wherein the first optical system includes a first lens unit that moves during zooming and has a positive refractive power, a second lens unit that moves during zooming and has a negative refractive power, and a third lens unit that moves during zooming and has a positive refractive power, and
wherein a distance between adjacent lens units in the first optical system changes during zooming.
